(19) United States
(12) Patent Application Publication
(10) Pub. No.: US 2017/0168560 A1
(43) Pub. Date: Jun. 15, 2017

(54) METHOD OF DISPLAYING AN "ATTITUDE DIRECTOR INDICATOR" IN A HEAD VIEWING SYSTEM FOR AIRCRAFT

(71) Applicant: THALES, Courbevoie (FR)

(72) Inventors: Romain SACHEAU, Merignac (FR); Bruno AYMERIC, St Medard (FR); Jonathan BARREAU, Bordeaux (FR)

(21) Appl. No.: 15/375,061

(22) Filed: Dec. 9, 2016

(30) Foreign Application Priority Data
Dec. 9, 2015 (FR) 1502562

(51) Int. Cl. G06F 3/01; B64D 43/00; G06F 1/16

(52) U.S. Cl. CPC G06F 3/012; G06F 1/163; B64D 43/00

(57) ABSTRACT

The general field of the invention is that of methods of displaying an “attitude director indicator” in a head viewing system for aircraft comprising:
a head support bearing a viewing device;
a detection of posture;
sensors for detecting the various parameters defining the attitude of the said aircraft;
means for computing and graphically generating the said attitude, the set of parameters displayed being termed the “attitude director indicator”;

In the method according to the invention, when the head support is oriented in a determined direction making, with the horizon line and/or with the “speed vector”, an angle greater than a first value, and/or when at least one of the attitude parameters of the aircraft becomes greater than a second value, the attitude director indicator is displayed locally in a reference frame tied to the head support and in the field of the viewing device.

The field of the invention is that of viewing systems worn on the head of a user for aeronautical applications.

These systems are used in the cockpits of civil and military aircraft to present the pilot with essential information relating to piloting or navigation. The information is displayed superimposed on the exterior landscape. These systems are known notably by the English term “See-through HMD”, “HMD” being the acronym of “Head Mounted Display”. They may be monocular or binocular.

This type of system always comprises two main sub-assemblies, the viewing system proper and a posture detection system allowing the posture of the user's head to be ascertained perfectly with respect to a known datum. Thus, it is possible to display information in a perfectly determined zone in space.

The viewing system mainly comprises a micro-imager which generates a synthetic image, relay optics and an optical combiner or mixer which makes it possible to superimpose the image arising from the relay optics on the exterior landscape.

Various techniques exist which make it possible to pinpoint an object in space. It is possible to use electromagnetic detection. An emitter is disposed in the fixed reference frame and a receiver in the moving reference frame. It is also possible to use optical detection which may be passive or active. In the latter case, the viewing device carries light-emitting diodes, the position of whose emission is pinpointed by cameras. All these techniques are known to the person skilled in the art. They are compatible with real-time operation and adapt easily to the viewing system according to the invention.

One of the advantages of this type of system is that it is possible to present information, notably symbology information, in a conformal position, that is to say perfectly superimposed with the position that they would occupy in the exterior landscape. Thus, it is possible to present the basic piloting information superimposed perfectly on the exterior. Conventionally, this information is gathered together in a view known by the terminology “ADI”, the acronym standing for “Attitude Director Indicator”. Basically, this view comprises an aeroplane mockup symbolically representing the craft and symbolics representing the attitude and the speed of the craft in terms of roll and pitch with respect to a terrestrial datum. This symbolics comprises at least one artificial horizon line and a roll scale. It is understood that, in order for this symbology to be easily interpretable, it must lie on the axis of the aircraft. When an ADI configuration is presented on a “See-through HMD”, it also includes a symbol called the “Speed Vector”, also referred to as the “Flight Path Vector” and known by the acronym “FPV”. This symbol represents the trajectory of the aeroplane, that is to say the direction towards which the aircraft is steering instantaneously. It therefore represents the course or “track” parameter, known by the acronym “TRK” and slope or “Flight Path Angle” parameter, known by the acronym “FPA”. On the other hand, the aeroplane mockup represents the direction of the nose of the aircraft in terms of heading angle and trim angle. The principles described hereinbelow are illustrated on the FPV, but they can apply to the aeroplane mockup if the FPV is not represented in the ADI.

One of the difficulties in presenting piloting information in a head viewing system is that, when the user turns their head, if the “ADI” symbolics is represented conventionally, it exits the visual field thereof.

To alleviate this difficulty, “parking” algorithms exist which bring the symbols required for piloting back to the field boundary. However, parking these symbols has the effect of causing them to lose the coherence of the information that they bear. For example, under a certain aircraft attitude condition, the speed vector may be parked above the horizon line, whilst in reality, it is situated below. Moreover, the representation of the symbol may no longer be suitable for a particular moment of the mission or of the flight phase.

The method according to the invention does not exhibit these drawbacks. Indeed, the “attitude director indicator” can be represented in a reference frame tied to the head support and, consequently, it is constantly in the user's field of vision. More precisely, the subject of the invention is a method of displaying an “attitude director indicator” in a head viewing system for aircraft, the said head viewing system comprising:
a head support bearing a viewing device;
a detection of posture of the said head support;
sensors for detecting the various parameters defining the attitude of the said aircraft;
means for computing and graphically generating the said attitude in the said viewing device, the set of parameters displayed in the form of symbols being termed the “attitude director indicator”, the said attitude director indicator being displayed in a determined angular field;

Characterized in that, when the head support is oriented in a determined direction making, with the horizon line and/or with the “speed vector” of the aircraft, an angle greater than a first determined value, and/or when at least one of the attitude parameters of the aircraft becomes greater than a second determined value, the attitude director indicator is displayed in a terrestrial reference frame or locally in a reference frame tied to the head support and in the field of the viewing device.

Advantageously, the attitude director indicator comprises a central symbol in the form of an aeroplane mockup representing the speed vector of the aircraft, this mockup comprises a first central circle surrounded by two symmetric straight dashes called winglets and surmounted by a third straight dash perpendicular to the two previous dashes.

Advantageously, when the head support is oriented in a determined direction making, with the horizon line and/or with the “speed vector”, an angle greater than a first determined value, the attitude director indicator comprises a symbol representative of this situation.

Advantageously, the representative symbol is a second circle whose angular diameter is a few degrees, the said second circle being centred on the first circle of the aeroplane mockup.

Advantageously, when the head support is oriented in a determined direction making with the “speed vector”, an angle greater than a first determined value, the three dashes of the mockup have as common point the centre of the first circle.

Advantageously, when the angle of roll exceeds a second determined value, a roll scale appears in the form of at least one circular arc, the number of arcs or the dimension of the arcs or the thickness of the dashes of the said arcs increasing with the increase in the roll, the said arcs being centred on the first circle.

Advantageously, when the angle of pitch exceeds a second determined value, a pitch symbol appears in the form of a chevron comprising, inside these two branches, a travelling scale, the travel rate being representative of the rate of variation of the pitch.

The invention will be better understood and other advantages will become apparent on reading the following nonlimiting description and by virtue of the appended figures among which:

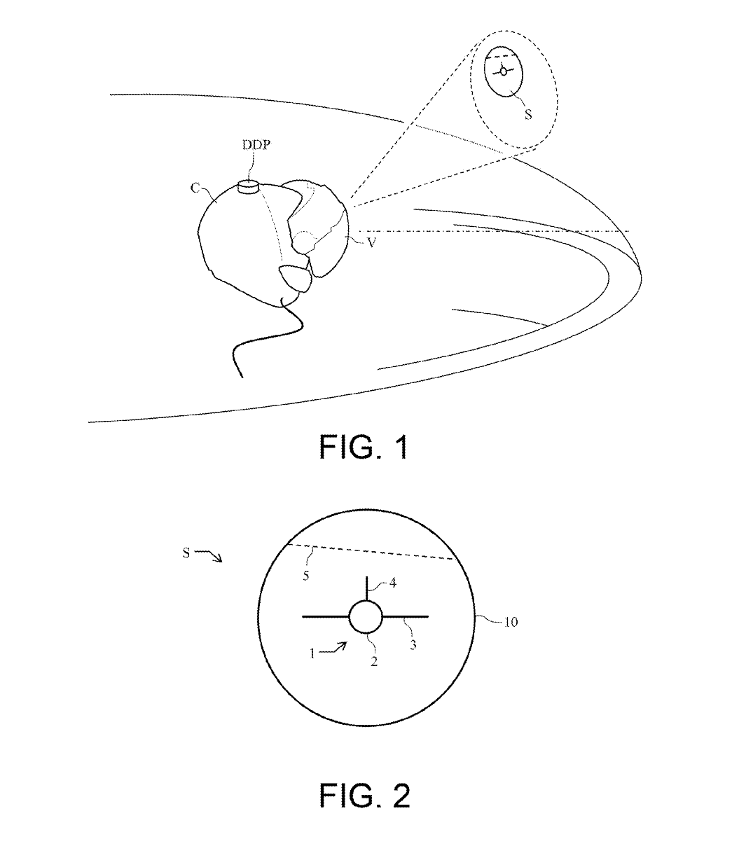

FIG. 1 represents a general view of a head viewing system implementing the method according to the invention;

FIG. 2 represents a first variant of the symbology implemented in the method according to the invention;

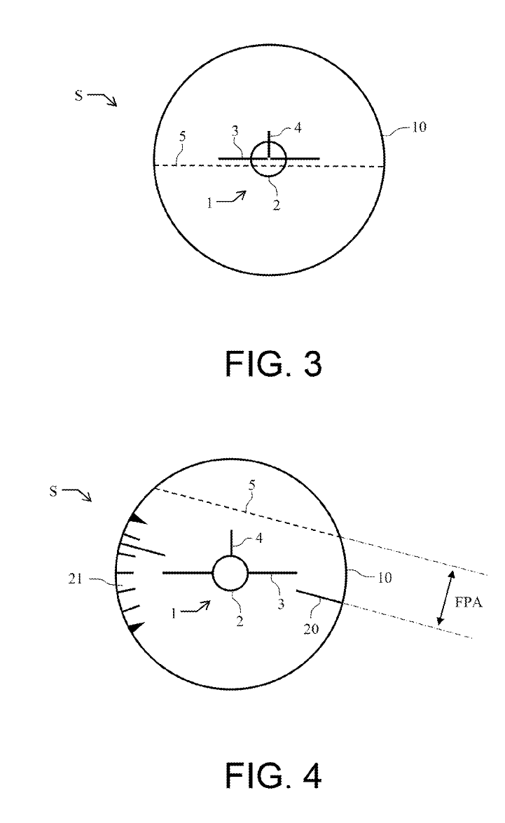

FIG. 3 represents a second variant of the symbology implemented in the method according to the invention;

FIG. 4 represents a third variant of the symbology implemented in the method according to the invention;

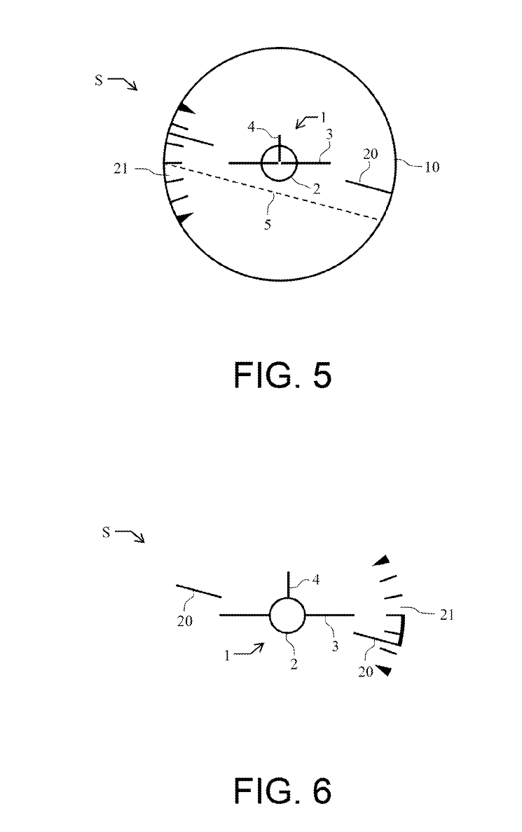

FIG. 5 represents a fourth variant of the symbology implemented in the method according to the invention;

FIG. 6 represents a fifth variant of the symbology implemented in the method according to the invention;

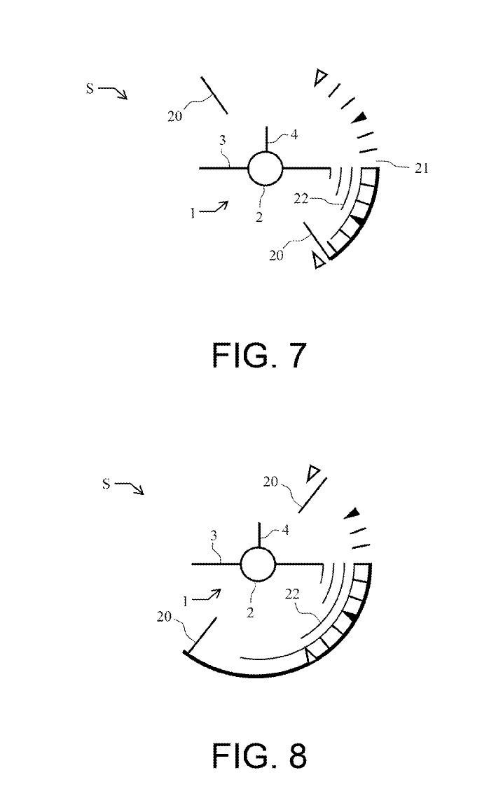

FIG. 7 represents a sixth variant of the symbology implemented in the method according to the invention;

FIG. 8 represents a seventh variant of the symbology implemented in the method according to the invention;

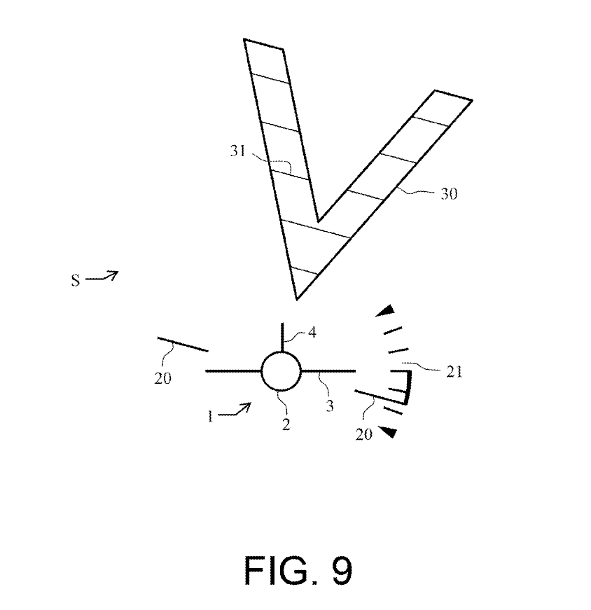

FIG. 9 represents an eighth variant of the symbology implemented in the method according to the invention.

The head viewing system according to the invention is represented schematically in FIG. 1. It comprises:
an equipped head support or headset C comprising an optoelectronic display assembly V. This viewing assembly can be monocular or binocular. When the head support or the headset is worn by a user, this assembly gives a collimated image arising from a display. This image is superimposed on the exterior landscape by an optical combiner or mixer;
a posture detection system DDP for the head support or for the headset making it possible to determine the position of the support or of the headset in the reference frame of the aircraft. There exist various detection systems which are well known to the person skilled in the art. Mention will be made of magnetic-detection systems in which a receiver measures the components of a known electromagnetic field and optical-detection systems comprising an emitter and a receiver which is able to determine the position and the orientation of this emitter by shape recognition. The position of the aircraft in a terrestrial reference frame is itself known by means of various sensors such as the inertial platform of the aircraft;
an electronic assembly or a computer, not represented in FIG. 1, ensuring the computation and the generation of a symbology S superimposed on the exterior landscape by the optoelectronic display assembly. This symbology generally comprises the basic information required for piloting such as the various indications of the speed, of the altitude and of the trim, the position of the horizon, etc. Conventionally, the set of parameters defining the attitude of the aircraft is termed the “Attitude Director Indicator”, also known, as was stated, by the acronym “ADI”. To ensure this function, the various sensors of the aircraft provide the computer with the information required. The headset orientation detection system gives it the position information and orientation information making it possible to display the symbology either in a conformal manner, that is to say in a terrestrial reference frame independent of the movements of the aircraft and of the movements of the headset, or in a non-conformal manner, that is to say in a reference frame tied to the user;
control means, generally one or more control posts making it possible to select, to modify or to validate the information and the data displayed by the viewing device. These control means can also be disposed on the control stick or be activated by voice control.

Conventionally, the attitude director indicator is displayed in a conformal position. One of the difficulties in presenting piloting information in a head viewing system is that, when the user turns their head, if the “ADI” symbolics is represented conventionally, it exits their visual field. That is to say that, on a head movement, it is possible to lose the display of the FPV or of the horizon line or of the roll scale which is a key element of the ADI when banking is engaged. In the method according to the invention, the representation of the FPV becomes, as a function of the direction of the head and of the flight parameters, the support to the symbology of the ADI, it being possible for this FPV representation to be tied to a terrestrial reference frame or to the headset. The attitude director indicator can therefore be displayed locally in a reference frame tied to the head support and in the field of the viewing device.

The method according to the invention is therefore advantageous when display in a conformal position is no longer possible. Hence, this method is implemented only, when the head support is oriented in a determined direction making, with the horizon line and/or with the “speed vector”, an angle greater than a first determined value. It is also beneficial to implement it, when at least one of the attitude parameters of the aircraft becomes greater than a second determined value.

Moreover, it is beneficial that the ADI according to the invention has a small visual “footprint”. That is to say that it comprises a minimum number of symbols. Consequently, the symbology comprises solely the symbols that are indispensable to the ADI and/or the symbols that are representative of a critical situation.

In the first typical case, the local ADI appears when the speed vector or the horizon line become limited, typically when the pilot wishes to look in a direction which positions the speed vector out-of-field. By “limited” symbol is meant a symbol not represented in a conformal position. When the pilot averts their gaze to perform a task other than piloting, the new representation of these flight parameters starts with a small visual footprint during nominal flight conditions and becomes augmented when the attitudes of the aircraft deteriorate.

In the second typical case, the local ADI appears when the attitudes of the aircraft become excessive as a function of parametrizable thresholds. So as not to mask the exterior vision of the pilot potentially accomplishing another task, the visual footprint level is gradual and increases when the parameters of the aircraft deteriorate greatly.

FIGS. 2 to 9 illustrate, by way of examples, these various configurations of symbologies S. To give an order of magnitude of the angular dimensions of the various symbologies seen by the pilot, the circle 10 which appears in FIGS. 2, 3, 4 and 5 has an apparent angular diameter of about 5 degrees. All these figures are to the same scale. The symbols consist essentially of dashes whose angular thickness is of the order of a milliradian or a few milliradians. All these symbols can be represented in monochrome or comprise several different colours. Generally, these symbols are green in colour. The colour red can be reserved for critical symbols.

All the FIGS. 2 to 9 are centred on an aeroplane mockup 1. It represents the speed vector of the aircraft. This mockup comprises a first central circle 2 surrounded by two symmetric straight dashes 3 called winglets and surmounted by a third straight dash 4 perpendicular to the two previous dashes.

FIGS. 2 to 5 illustrate the first typical case which corresponds to the appearance of the ADI when the speed vector or the horizon line become limited. These four figures are all surrounded by the circle 10 which appears when the speed vector or the horizon line become limited. This circle 10 is centred on the FPV 1. In these figures, the horizon line is represented by a dashed line 5.

FIG. 2 represents the simplest configuration. It comprises the FPV 1 and the circle 10 indicating that the horizon line 5 is limited, the horizon line has exited the display field. The three dashes 3 and 4 of the FPV which are representative of the wings and of the fin are deployed, indicating that only the horizon line is limited, the speed vector or FPV having a nominal value. It is therefore still displayed in a terrestrial reference frame. The absence of roll indication in this figure also signifies that the roll remains within nominal limits. This limit is, for example, +/−10 degrees.

In FIG. 3, the speed vector or FPV has a limited value. It is displayed at the field boundary in the direction in which the head must turn to “retrieve” it. The three dashes 3 and 4 of the FPV which are representative of the wings and of the fin are then retracted and pass through the centre of the circle 2. The absence of roll indication in this figure also signifies that the roll remains within nominal limits.

In FIGS. 4 and 5, the roll has become more significant. Two roll bars 20 whose inclination is representative of the value of the roll appear at the periphery of the circle 10. A roll scale 21 also appears. The angle of inclination between the horizon bar and the roll bars is representative of the angle of inclination of the speed vector with respect to the horizontal. This angle is known by the acronym “FPA”, standing for “Flight Path Angle”.

In FIG. 4, the three dashes 3 and 4 of the FPV which are representative of the wings and of the fin are deployed, indicating that only the horizon line is limited, the speed vector or FPV having a nominal value. In FIG. 5, the speed vector or FPV has a limited value. The three dashes 3 and 4 of the FPV which are representative of the wings and of the fin are then retracted.

FIGS. 6 to 9 illustrate the second typical case which corresponds to the appearance of the ADI when the attitudes of the aircraft become excessive as a function of parametrizable thresholds. For greater clarity, in these examples, the speed vector and the horizon line are not limited and do not therefore appear in these figures.

FIGS. 6 to 8 illustrate the case of a roll becoming increasingly significant. In FIG. 6, the roll is around 10 degrees. As in FIG. 5, the bars 20 and the roll scale 21 appear. In FIG. 7, the roll is greater than 30 degrees. The roll scale is accompanied by several concentric circular arcs 22, indicating to the pilot an excessive roll. In FIG. 8, the roll is greater than 60 degrees. The concentric circular arcs 22 get stronger. The symbol composed of several concentric circular arcs makes it possible also to retain the notion of the direction of roll when it approaches the limit values.

Thus, the number of arcs or the dimension of the arcs or the thickness of the dashes of the said arcs increase with increasing roll, the said arcs being centred on the mockup.

FIG. 9 represents the symbology in the case where the pitch of the aircraft becomes excessive. When the angle of pitch exceeds a determined value, a pitch symbol appears in the form of a chevron 30 comprising, inside these two branches, a travelling scale 31, the travel rate being representative of the rate of variation of the pitch. This information gives the pilot a more precise feel of the dynamics of their aircraft during more abrupt maneuvers. If the pitch variation is very significant, it is possible to anticipate the rate of variation of the pitch so as to remain below the limit values.

When the local ADI is displayed, the real horizon line is erased around the local ADI so that the pilot cannot confuse the various types of representation, one being conformal and represented by the standard ADI and the other non-conformal and represented by the local ADI.

1. A method of displaying an “attitude director indicator” in a head viewing system for aircraft, the said head viewing system comprising:
a head support bearing a viewing device;
a detection of posture of the said head support;
sensors for detecting the various parameters defining the attitude of the said aircraft;
means for computing and graphically generating the said attitude in the said viewing device, the set of parameters displayed in the form of symbols being termed the “attitude director indicator”, the said attitude director indicator being displayed in a determined angular field;
wherein, when the head support is oriented in a determined direction making, with the horizon line and/or with the “speed vector”, an angle greater than a first determined value, and/or when at least one of the attitude parameters of the aircraft becomes greater than a second determined value, the attitude director indicator is displayed in a terrestrial reference frame or locally in a reference frame tied to the head support and in the field of the viewing device.

2. The method of display according to claim 1, wherein the visual footprint of the attitude director indicator is gradual and increases when the parameters of the aircraft deteriorate.

3. The method of display according to claim 1, wherein the attitude director indicator comprises a central symbol in the form of an aeroplane mockup representing the speed vector of the aircraft, this mockup comprising a first central circle surrounded by two symmetric straight dashes called winglets and surmounted by a third straight dash perpendicular to the two previous dashes.

4. The method of display according to claim 1, wherein, when the head support is oriented in a determined direction making, with the horizon line and/or with the “speed vector”, an angle greater than a first determined value, the attitude director indicator comprises a symbol representative of this situation.

5. The method of display according to claim 4, wherein, the representative symbol is a second circle whose angular diameter is a few degrees, the said second circle being centred on the first circle of the aeroplane mockup.

6. The method of display according to claim 1, wherein, when the head support is oriented in a determined direction making with the “speed vector”, an angle greater than a first determined value, the three dashes of the mockup have as common point the centre of the first circle.

7. The method of display according to claim 1, wherein, when the angle of roll exceeds a second determined value, a roll scale appears in the form of at least one circular arc, the number of arcs or the dimension of the arcs or the thickness of the dashes of the said arcs increasing with the increase in the roll, the said arcs being centred on the first circle.

8. The method of display according to claim 1, wherein, when the angle of pitch exceeds a second determined value, a pitch symbol appears in the form of a chevron comprising, inside these two branches, a travelling scale, the travel rate being representative of the rate of variation of the pitch.
